(19) United States
(12) Patent Application Publication
(10) Pub. No.: US 2025/0239797 A1
(43) Pub. Date: Jul. 24, 2025

(54) CONNECTOR

(71) Applicant: SUMITOMO WIRING SYSTEMS, LTD., Mie (JP)

(72) Inventor: Eisaku IWAKURA, Mie (JP)

(21) Appl. No.: 18/701,409

(22) PCT Filed: Oct. 7, 2022
(86) PCT No.: PCT/JP2022/037615

§ 371 Date: Apr. 15, 2024

(30) Foreign Application Priority Data
Oct. 27, 2021 (JP) 2021-175409

(51) Int. Cl. H01R 13/405

(52) U.S. Cl. CPC H01R 13/405

(57) ABSTRACT

A connector includes a low voltage terminal including a first connector terminal portion, a second connector terminal portion and a relay conductor portion between the first and second connector terminal portions, a busbar terminal in the form of a long plate, and a connector housing including a first resin portion for covering the relay conductor portion and a second resin portion for covering the relay conductor portion, the first resin portion and an intermediate part in an extension direction of the busbar terminal. The first resin portion includes a projecting portion projecting toward the busbar terminal in at least a part of a region overlapping the busbar terminal along a thickness direction of the busbar terminal.

### TECHNICAL FIELD

The present disclosure relates to a connector.

### BACKGROUND

Patent Document 1 discloses a connector in which a small connector is integrally molded with a connector housing molded with terminal fittings as inserts.

### PRIOR ART DOCUMENT

### Patent Document

Patent Document 1: JP 2012-195065 A

### SUMMARY OF THE INVENTION

### Problems to be Solved

Depending on the connected positions of the terminal fittings and the connected position of the small connector, a relay conductor portion connecting connector terminals of the small connector and the terminal fittings possibly face each other via a resin part. In such a case, the resin part interposed between the relay conductor portion and the terminal fittings is desired to suppress the formation of voids due to thermal contraction.

Accordingly, the present disclosure aims to suppress the formation of voids due to thermal contraction in a resin part between a busbar terminal and a low voltage terminal.

### Means to Solve the Problem

The present disclosure is directed to a connector with a low voltage terminal including a first connector terminal portion, a second connector terminal portion and a relay conductor portion between the first and second connector terminal portions, a busbar terminal in the form of a long plate, and a connector housing including a first resin portion for covering the relay conductor portion and a second resin portion for covering the relay conductor portion, the first resin portion and an intermediate part in an extension direction of the busbar terminal, the first resin portion including a projecting portion projecting toward the busbar terminal in at least a part of a region overlapping the busbar terminal when viewed along a thickness direction of the busbar terminal.

### Effect of the Invention

According to the present disclosure, the formation of voids due to thermal contraction can be suppressed in a resin part between a busbar terminal and a low voltage terminal.

### BRIEF DESCRIPTION OF THE DRAWINGS

FIG. 1 is a front view showing a connector according to an embodiment.

FIG. 2 is an exploded perspective view showing the connector.

FIG. 3 is an exploded perspective view of the connector when viewed from a direction different from that in FIG. 2.

FIG. 4 is a section along IV-IV in FIG. 2 of the connector in an assembled state.

FIG. 5 is a section along V-V in FIG. 3 of the connector in the assembled state.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector is provided with a low voltage terminal including a first connector terminal portion, a second connector terminal portion and a relay conductor portion between the first and second connector terminal portions, a busbar terminal in the form of a long plate, and a connector housing including a first resin portion for covering the relay conductor portion and a second resin portion for covering the relay conductor portion, the first resin portion and an intermediate part in an extension direction of the busbar terminal, the first resin portion including a projecting portion projecting toward the busbar terminal in at least a part of a region overlapping the busbar terminal when viewed along a thickness direction of the busbar terminal.

According to this connector, a distance between the first resin portion and the busbar terminal is reduced and the second resin portion can be thinned in a part formed with the projecting portion. In this way, the formation of voids due to the thermal contraction of the second resin portion can be suppressed in a part between the busbar terminal and the low voltage terminal. Since the projecting portion is a partial projecting part in the first resin portion, a volume of the entire first resin portion is not increased so much. Thus, the amount of thermal contraction of the first resin portion can be reduced as compared to the case where the entire first resin portion is thickened. In this way, the formation of voids due to the thermal contraction of the first resin portion is also suppressed.

(2) In the connector of (1), the second resin portion may include a nut accommodation recess for accommodating a nut in contact with one principal surface of one end part of the busbar terminal, and the low voltage terminal may be located away from the busbar terminal by a thickness of the nut or more in the thickness direction of the busbar terminal in the connector housing.

Even if the second resin portion includes the nut accommodation recess for accommodating the nut in contact with the one principal surface of the one end part of the busbar terminal in this way, the formation of voids due to thermal contraction can be suppressed while a distance between the busbar terminal and the low voltage terminal is ensured by the projecting portion.

(3) In the connector of (1) or (2), the connector housing may include a low voltage connector housing portion surrounding the first connector terminal portion, the busbar terminals may include a first busbar terminal, the low voltage connector housing portion may be located on an extension of one end part of the first busbar terminal, and the projecting portion may include a part projecting toward the first busbar terminal in at least a part of a region overlapping the first busbar terminal when viewed along a thickness direction of the first busbar terminal.

If the low voltage connector housing portion is located on the extension of the one end part of the first busbar terminal in this way, it becomes difficult to form a lightened structure between the first busbar terminal and the low voltage terminal. In this part, the second resin portion can be thinned by the projecting portion of the first resin portion.

(4) In the connector of (3), the second resin portion may include a first nut accommodation recess for accommodating a first nut in contact with one principal surface of the one end part of the first busbar terminal, and the first nut accommodation recess may be open in a direction intersecting an extension direction of the one end part of the first busbar terminal. In this way, the first nut accommodation recess can be easily formed without being interrupted by the low voltage connector housing portion.

(5) In the connector of claim (4), the busbar terminals may include a second busbar terminal arranged at an interval from and in parallel to the first busbar terminal, the second resin portion may include a second nut accommodation recess for accommodating a second nut in contact with one principal surface of one end part of the second busbar terminal, and the second nut accommodation recess may be open toward a tip side of the first busbar terminal.

Since being open toward the tip side of the busbar terminal in this way, the second nut accommodation recess can be easily formed.

(6) In the connector of any one of (1) to (5), the busbar terminal may include a bent part bent to be displaced in a width direction thereof, and the projecting portion may be formed into a shape projecting according to the shape of the bent part in the width direction of the busbar terminal. In this way, the second resin portion can be thinned between the busbar terminal and the low voltage terminal in as large a region as possible according to the shape of the bent part of the busbar terminal.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

Hereinafter, a connector according to an embodiment is described.

### <Concerning Overall Configuration of Connector>

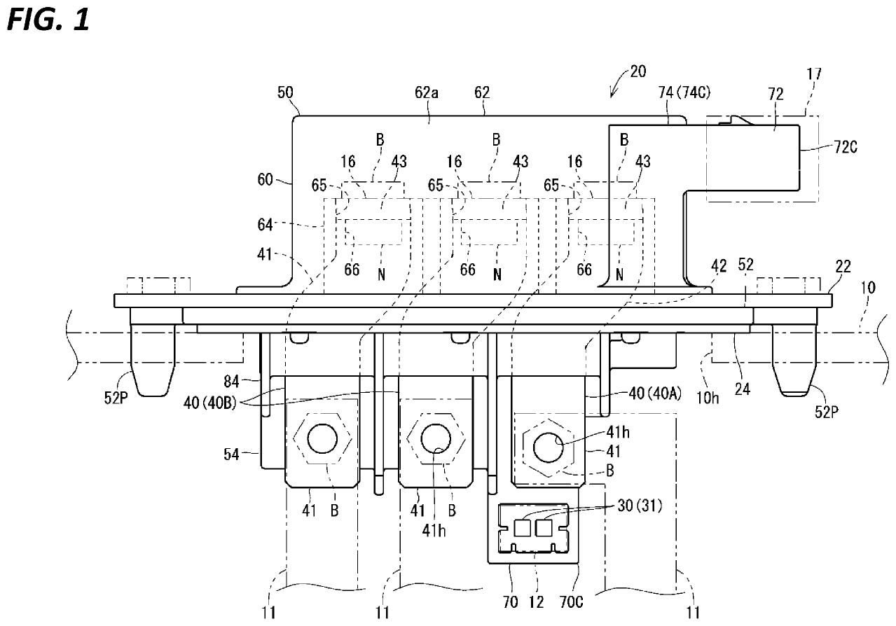

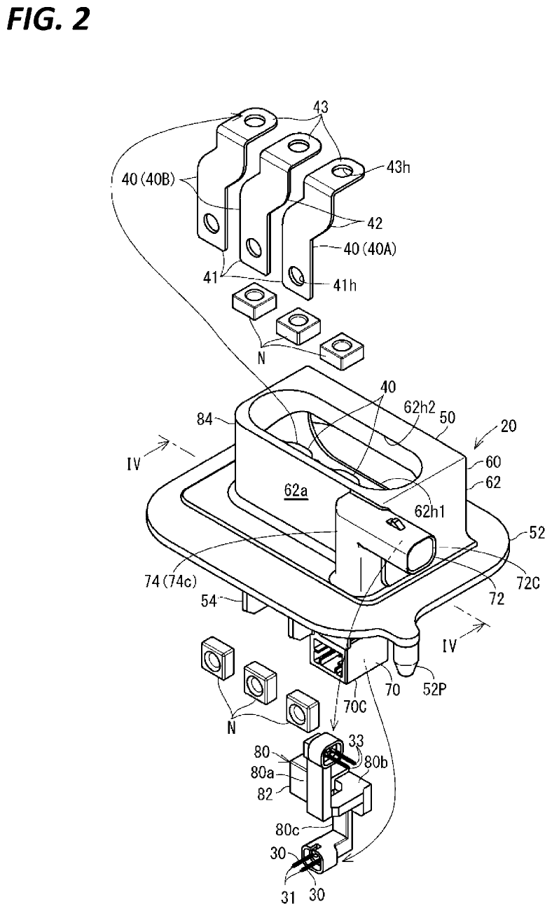

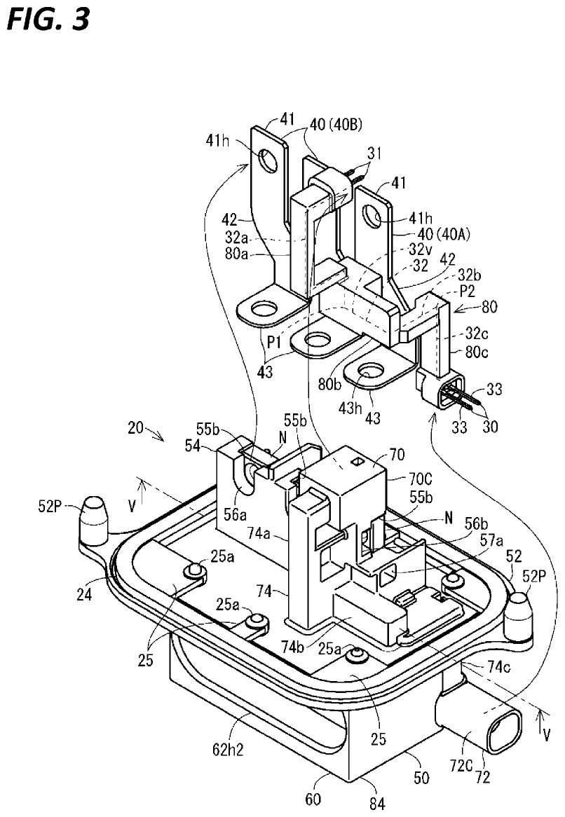

FIG. 1 is a front view showing a connector 20. A case 10 of a device, on which the connector 20 is to be mounted, and parts to be connected are shown in FIG. 1. FIG. 2 is an exploded perspective view showing the connector 20. In FIG. 2, busbar terminals 40, low voltage terminals 30, a first resin portion 80 and nuts N in the connector 20 are shown in a disassembled state in the same postures as those in the connector 20. FIG. 3 is an exploded perspective view of the connector 20 when viewed from a direction different from that in FIG. 2. In FIG. 3, the busbar terminals 40, the low voltage terminals 30 and the first resin portion 80 are shown in a disassembled state in the same postures as those in the connector 20. A positional relationship of the low voltage terminals 30 and the first resin portion 80 with respect to the busbar terminals 40 shown in FIG. 3 is the same as a positional relationship in a connector housing 50.

The connector 20 is used as a component to be mounted on the case 10 of the device for electrically connecting electrical components inside and outside the device. The device is, for example, a motor generator serving as a drive motor and a generator, or an inverter for driving a motor or the like in an automotive vehicle. Such a device is thought to be provided with a high voltage circuit and a low voltage circuit for signal. In FIG. 1, high voltage internal busbars 11 and a low voltage internal connector 12 are shown in the case 10. The high voltage internal busbars 11 and the low voltage internal connector 12 may be supported at fixed positions and in fixed postures in the case 10 or may be movable in the case 10. High voltage external terminals 16 and a low voltage external connector 17 are arranged outside the case 10. Note that the high voltage external terminals 16 may be terminals mounted on end parts of high voltage cables or terminals supported to project outward in another device. Further, the low voltage external connector 17 may be a connector mounted on an end part of a signal wire or may be a connector supported to project outward in another device.

The case 10 is formed with a connection opening 10h. The connector 20 is mounted on the case 10 while being passed through this opening 10h. The connector 20 is provided with the low voltage terminals 30, the busbar terminals 40 and the connector housing 50. The low voltage terminals 30 and the busbar terminals 40 are held at fixed positions and in fixed postures by the connector housing 50. That is, the low voltage terminals 30 do not relatively move with respect to the busbar terminals 40.

With the connector 20 mounted on the case 10, one end part of each busbar terminal 40 is connected to the high voltage internal busbar 11 in the case 10 and the other end part of each busbar terminal 40 is connected to the high voltage external terminal 16 outside the case 10. Further, one end part of each low voltage terminal 30 is connected to a connector terminal of the low-voltage internal connector 12 in the case 10, and the other end part of the low voltage terminal 30 is connected to a connector terminal of the low voltage external connector 17 outside the case 10. In this way, the high voltage circuit and the low voltage circuit for signal in the case 10 are electrically connected to a high voltage circuit and a low voltage circuit for signal outside the case 10 via the connector 20.

In this embodiment, the connector housing 50 includes a plate-like portion 52. Further, the connector 20 is provided with a metal plate 22 and an annular seal 24. The metal plate 22 is made of metal or the like and overlaid on an outer peripheral part of the plate-like portion 52. The connector 20 is fixed watertight to the case 10, using the plate-like portion 52, the metal plate 22 and the annular seal 24. Each component is more specifically described below.

### <Busbar Terminals>

The busbar terminal 40 is a long plate-like member formed, such as by press-working a metal plate material. The busbar terminal 40 is, for example, made of copper or copper alloy. In this embodiment, the busbar terminal 40 is formed into a long shape in which a first end part 41, an intermediate part 42 and a second end part 43 are connected in this order. The first end part 41 and the intermediate part 42 are connected on the same plane. The second end part 43 is bent with respect to the intermediate part 42. In this embodiment, the second end part 43 is bent at 90° with respect to the intermediate part 42. The busbar terminal 40 is a high voltage terminal, and a voltage higher than a voltage to be applied to the low voltage terminal 30 is, for example, applied thereto. A voltage of 60 V or higher is, for example, applied to the busbar terminal 40. In this embodiment, a voltage of 200 V or higher is applied to the busbar terminal 40.

The first end part 41 is formed with a bolt insertion hole 41h, and the high voltage internal busbar 11 is fixed to the first end part 41 by a bolt. The second end part 43 is formed with a bolt insertion hole 43h, and the high voltage external terminal 16 is fixed to the second end part 43 by a bolt.

The intermediate part 42 is an example of a bent part bent to displace the busbar terminal 40 in a width direction thereof. In this embodiment, the intermediate part 42 is bent into a crank shape. More specifically, out of the intermediate part 42, both end parts connected to the first and second end parts 41, 43 are parallel to each other, but an intermediate part therebetween extends in a direction intersecting the both end parts. Thus, the both end parts of the intermediate part 42 are shifted in the width direction thereof. Further, the first and second end parts 41, 43 are shifted from each other in the width direction. It is not essential that the intermediate part 42 is bent, and the intermediate part 42 may extend straight.

The connector 20 in this embodiment includes three busbar terminals 40. It is sufficient for the connector 20 to include one or more busbar terminals. Note that, in the following description, the three busbar terminals 40 may be distinguished such that the one located on one end in a parallel direction is a first busbar terminal 40 and the others are second busbar terminals 40B.

### <Low Voltage Terminals>

The low voltage terminal 30 is an elongated plate-like member formed, such as by press-working a metal plate material. The low voltage terminal 30 is, for example, made of copper or copper alloy. In this embodiment, the low voltage terminal 30 is formed into a long shape in which a first connector terminal portion 31, a relay conductor portion 32 (see FIGS. 3 to 5) and a second connector terminal portion 33 are connected in this order.

The first connector terminal portions 31 are formed straight, and a first low voltage connector housing portion 70 to be described later surrounds the first connector terminal portions 31. A first low voltage connector 70C is constituted by the first low voltage connector housing portion 70 and the first connector terminal portions 31. The low voltage internal connector 12 is connected to this first low voltage connector 70C. The first low voltage connector 70C is located on an extension of one end part of the first busbar terminal 40A.

The second connector terminal portions 33 are formed straight, and extend from a bottom part of a second low voltage connector housing portion 72 to be described later toward an opening. A second low voltage connector 72C is constituted by the second low voltage connector housing portion 72 and the second connector terminal portions 33. The low voltage external connector 17 is connected to this second low voltage connector 72C.

In the connector 20, the first low voltage connector 70C is provided at a position suitable for connection to the low voltage internal connector 12 in the case 10, and the second low voltage connector 72C is provided at a position suitable for connection to the low voltage external connector 17 outside the case 10.

The relay conductor portion 32 is bent along a path linking the first and second low voltage connectors 70C, 72C through the case 10 while avoiding contact with the busbar terminals 40 in the connector housing 50 between the first and second connector terminal portions 31, 32. An example of the bent relay conductor portion 32 is shown in FIG. 3. The relay conductor portion 32 includes, for example, a first neck portion 32a, an intermediate coupling portion 32b and a second neck portion 32c. The first neck portion 32a extends from the first low voltage connector 70C toward the second low voltage connector 72C along an center axis direction of the opening 10H. In this embodiment, the first neck portion 32a includes a part detouring in a direction separating from the busbar terminals 40. The second neck portion 32c is a part extending from the second low voltage connector 72C toward the first low voltage connector 70C along the center axis direction of the opening 10h. The first and second neck portions 32a, 32c extend to an intermediate position between the first and second low voltage connectors 70C, 72C in a direction along the center axis direction of the opening 10h. When viewed in the direction along the center axis direction of the opening 10h, a base end part P1 of the first neck portion 32a and a base end part P2 of the second neck portion 32c are present at mutually different positions (see FIG. 3).

The intermediate coupling portion 32b extends while being bent along a path avoiding the busbar terminals 40 in the connector housing 50, and links the base end part P1 of the first neck portion 32a and the base end part P2 of the second neck portion 32c. The intermediate coupling portion 32b includes a part overlapping the intermediate part 42 when viewed along a thickness direction of the intermediate part 42 of the busbar terminal 40. In this embodiment, an intermediate part of the intermediate coupling portion 32b serves as an intersecting portion 32v extending along a parallel direction of a plurality of the intermediate parts at a position separated from the intermediate parts 42 of the plurality of busbar terminals 40 along the thickness direction of the intermediate parts 42. A part of this intersecting portion 32v overlaps one of the plurality of intermediate parts 42 when viewed along the thickness direction of the intermediate parts 42 of the busbar terminals 40.

The shape, position and posture of the intermediate coupling portion 32b in the connector housing 50 are arbitrary without being limited to those of the above example. The intermediate coupling portion 32b may extend obliquely to the intermediate parts 42 or extend along the same direction as the intermediate parts 42. The intermediate coupling portion 32b may be at a position separated from the intermediate parts 42 by a thickness of the nuts N or more in the thickness direction of the intermediate parts 42 of the busbar terminals 40 in the connector housing 50.

In this embodiment, the connector 20 includes two low voltage terminals 30. It is sufficient for the connector 20 to include one or more low voltage terminals 30.

The low voltage terminal 30 is a low voltage terminal for signal transmission, and a voltage lower than a voltage to be applied to the busbar terminal 40 is, for example, applied to the low voltage terminal 30. A voltage of 10 V or lower is, for example, applied to the low voltage terminal 30. The low voltage terminal 30 is thinner than the busbar terminal 40. Further, a transverse cross-sectional area (cross-sectional area on a plane orthogonal to a longitudinal direction) of the low voltage terminal 30 is smaller than that of the busbar terminal 40.

### <Connector Housing>

The connector housing 50 is an insulated part made of resin. The low voltage terminals 30 and the busbar terminals 40 are supported at positions and postures suitable for connection by the connector housing 50.

The connector housing 50 includes the plate-like portion 52, a first connector portion 54 and a second connector portion 60. The plate-like portion 52 is in the form of a rectangular plate. The first connector portion 54 projects on one principal surface side of the plate-like portion 52, and the second connector portion 60 projects on the other principal surface side of the plate-like portion 52. An outer peripheral part of the plate-like portion 52 projects outward from between and around the first and second connector portions 54, 60, thereby forming a flange part.

The plate-like portion 52 is in the form of a plate expanding larger than the opening 10H. The annular seal 24 is arranged on an outer peripheral part of the one principal surface of the plate-like portion 52. The annular seal 24 includes mounting pieces 25 projecting inward. The mounting pieces 25 are mounted on the plate-like portion 52. For example, pin portions 25a including a head part project on the plate-like portion 52 and are inserted through holes formed in the mounting pieces 25, and the head parts are caught by peripheral edge parts of the through holes, whereby the annular seal 24 is mounted on the plate-like portion 52. A mounting structure of the annular seal 24 is not limited to the above example. A configuration for sealing is also not limited to the above example.

The plate-like portion 52 includes positioning protrusions 52P. The positioning protrusion 52P projects in a direction orthogonal to the plate-like portion 52 from the outer peripheral part of the one principal surface of the plate-like portion 52. By inserting the positioning protrusions 52 into guide holes formed in the case 10 in mounting the connector 20 on the case 10, the connector 20 is guided to be arranged at a predetermined mount position with respect to the case 10.

The metal plate 22 is arranged to be overlaid on an outer peripheral part of the other principal surface of the plate-like portion 52. The metal plate 22 is made of metal or the like, and formed with an opening, into which the second connector portion 60 can be arranged, in a central part thereof. The first connector portion 54 is arranged more inward than the opening 10h of the case 10, and the plate-like portion 52 and the metal plate 22 are overlaid on an outward facing surface of the case 10 around the opening 10h. The metal plate 22 is formed with bolt insertion holes.

With the first connector portion 54 arranged in the opening 10h, the outer peripheral part of the plate-like portion 52 is arranged to face the outward facing surface of the case 10 around the opening 10h. In this state, the annular seal 24 is arranged between the case 10 and the plate-like portion 52 around the opening 10h. Further, in this state, the metal plate 22 is fastened and fixed to the case 10 by bolts B. In this way, the annular seal 24 is compressed between the case 10 and the plate-like portion 52 to stop water between the case 10 and the connector housing 50.

The first connector portion 54 is a part for supporting parts of the busbar terminals 40 near the first end parts 41. In this embodiment, out of the plurality of (three) busbar terminals 40, the parts near the first end parts 41 are arranged at intervals in parallel. The first connector portion 54 projects from the one principal surface of the plate-like portion 52, covers around the parts near the first end parts 41, out of the three busbar terminals 40, and is interposed between the respective busbar terminals 40.

A base end part of the first connector portion 54 entirely covers around the parts of the intermediate parts 42 near the first end parts 41. The one principal surface of each first end part 41 is exposed to outside in a tip part of the first connector portion 54. A first nut accommodation recess 55a and second nut accommodation recesses 55b for accommodating the nuts N in a rotation stopped state are formed in a part of the first connector portion 54 facing the other principal surfaces of the first end parts 41. Since the nuts N are square nuts in this embodiment, the first and second nut accommodation recesses 55a, 55b are in the form of square holes. The first and second nut accommodation recesses 55a, 55b are formed in a second resin portion 84 to be described later.

The first nut accommodation recess 55a corresponds to the first end part 41 of the first busbar terminal 40A, and the second nut accommodation recesses 55b correspond to the first end parts 41 of the second busbar terminals 40B.

The first nut accommodation recess 55a is open in a direction intersecting an extension direction of the first end part 41 of the first busbar terminal 40A. More specifically, the first nut accommodation recess 55a is open in a horizontal direction orthogonal to the extension direction of the first end part 41 of the first busbar terminal 40A toward a side opposite to the other second busbar terminals 40B. Thus, the nut N is fittable into the first nut accommodation recess 55a from a lateral outer side of the first connector portion 54.

The nut N is held in contact with the other principal surface of the first end part 41 in the first nut accommodation recess 55a. Note that5 a U-shaped escape recess 56a is formed in a part opposite to the first busbar terminal 40A with respect to the first nut accommodation recess 55a, out of the first connector portion 54. The escape recess 56a is also open in the direction intersecting the extension direction of the first end part 41 of the first busbar terminal 40A, similarly to the first nut accommodation recess 55a. Thus, the first nut accommodation recess 55a and the escape recess 56a can be formed by removing a mold in the same direction during molding.

The second nut accommodation recess 55b is open toward a tip side along the extension direction of the first end part 41. Thus, the nut N is fittable into the second nut accommodation recess 55b from a tip part of the first connector portion 54. The nut N is held in contact with the other principal surface of the second end part 43 in the second nut accommodation recess 55b. Note that a U-shaped escape recess 56b is formed in a part opposite to the first busbar terminal 40A with respect to the second nut accommodation recess 55b, out of the first connector portion 54. The escape recess 56b is also open toward the tip side along the extension direction of the first end part 41, similarly to the second nut accommodation recess 55b. Thus, the second nut accommodation recess 55b and the escape recess 56b can be formed by removing a mold in the same direction during molding.

With the high voltage internal busbars 11 overlapped on the first end parts 41 of the busbar terminals 40 from a side opposite to the nuts N, the bolts B are inserted through the bolt insertion holes of the high voltage internal busbars 11 and the bolt insertion holes 43h of the busbar terminals 40 and screwed into the nuts N in the nut accommodation recesses 55a, 55b. In this way, the high voltage internal busbars 11 are fastened and fixed to the first end parts 41 of the busbar terminals 40 by the bolts. Note that, in tightening the bolt B into the nut N, a tip part of the nut N projecting from the nut N can enter the escape recess 56a, 56b.

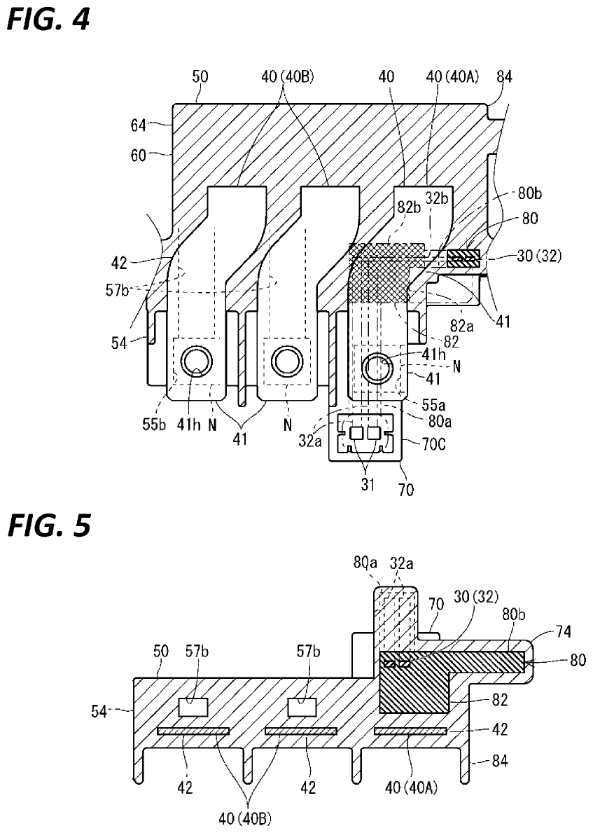

Note that escape holes 57b along the extension direction of the first end parts 41 of the second busbar terminals 40B are formed on the back of the second nut accommodation recesses 55b, out of the first connector portion 54 (see FIGS. 4 and 5). The escape hole 57b is a space narrower than the second nut accommodation recess 55b, and the nut N does not enter the escape hole 57b. The connector housing 50 is suppressed from being thick around the intermediate parts 42 of the second busbar terminals 40B by the escape holes 57b. An escape hole 57a open in a lateral side of the first connector portion 54 is formed at a position closer to a base end than the first nut accommodation recess 55a, out of the first connector portion 54 (see FIG. 3). The connector housing 50 is suppressed from being thick around the intermediate part 42 of the first busbar terminal 40a by the escape holes 57a.

The second connector portion 60 is a part for supporting parts of the busbar terminals 40 near the second end parts 43. In this embodiment, the second connector portion 60 includes an outer wall portion 62 and a base portion 64. The base portion 64 projects from a central part of the other principal surface of the plate-like portion 52 and covers around and between the intermediate parts 42 of the plurality of busbar terminals 40. A tip part of the base portion 64 is formed with busbar end accommodation recesses 65 capable of accommodating the second end parts 43 of the plurality of busbar terminals 40. The busbar end accommodation recess 65 is in the form of a shallow groove extending in a direction intersecting (here, orthogonal to) the intermediate part 42. The plurality of second end parts 43 are accommodated at intervals in parallel in the corresponding busbar end accommodation recesses 65. In this state, outward facing surfaces of the second end parts 43 are exposed to outside. Nut accommodation recesses 66 are formed on the back of the busbar end accommodation recesses 65, out of the base portion 64. The nuts N are accommodated in the nut accommodation recesses 66 in a rotation stopped state while being held in contact with inward facing surfaces of the second end parts 43. Escaping recesses are formed on the back of the nut accommodation recesses 66. The nut accommodation recesses 66 and the escape recesses are open toward tip sides of the second end parts 43 in an extension direction of the second end parts 43. The nut accommodation recesses 66 are formed in the second resin portion 84 to be described later.

The outer wall portion 62 is formed into a rectangular parallelepiped shape surrounding the base portion 64. A part of the outer wall portion 62 is a main wall portion 62a connected to the base portion 64. Openings 62h1, 62h2 are formed in a part opposite to the main wall portion 62a and a part opposite to the plate-like portion 52, out of the outer wall portion 62. The opening 62h1 is open toward the tip sides of the second end parts 43, and the opening 62h2 is open on extensions of center axes of the bolt insertion holes 43h of the second end parts 43.

The plurality of high voltage external terminals 16 are overlaid on the corresponding second end parts 43. At this time, a wiring member connected to the high voltage external terminals 16, e.g. a high voltage harness, passes through the opening 62h1, thereby being easily arranged on the second end parts 43 from outside. In this state, the bolt B is inserted through the bolt insertion hole formed in the high voltage external terminal 16 and the bolt insertion hole 43h formed in the second end part 43 and screwed and tightened into the nut N in the nut accommodation recess 66. At this time, a bolt tightening tool can be engaged with the head part of the bolt B through the opening 62h2, wherefore a tightening operation of the bolt B is easily performed. In this way, the high voltage external terminal 16 is connected to the second end part 43 of the busbar terminal 40 by tightening the bolt B.

The connector housing 50 includes the first low voltage connector housing portion 70, a second low voltage connector housing portion 72 and an intermediate path covering portion 74.

The first low voltage connector housing portion 70 is located on an extension of the tip side of the first end part 41 of the first busbar terminal 40A. The first low voltage connector housing portion 70 is open in a direction intersecting the first end part 41, here in an orthogonal direction. By providing the first end parts 41 of the low voltage terminals 30 to extend from a back part of the first low voltage connector housing portion 70 toward the opening, the first low voltage connector 70C is configured. By inserting the low voltage internal connector 12 into the first low voltage connector 70C, the first end parts of the low voltage terminals 30 are electrically connected to the connector terminals of the low voltage internal connector 12. A connection direction of the low voltage internal connector 12 to the first low voltage connector 70C is arbitrary and not limited to that of the above example.

The second low voltage connector housing portion 72 is located on an outer side in the parallel direction of the plurality of busbar terminals 40. Further, the second low voltage connector housing portion 72 is located on a side opposite to the first low voltage connector housing portion 70 with respect to a plane including the intermediate parts 42 of the plurality of busbar terminals 40. The second low voltage connector housing portion 72 is open in a direction intersecting the second end parts 43, here in an orthogonal direction. By providing the second end parts 43 of the low voltage terminals 30 to extend from a back part of the second low voltage connector housing portion 72 toward the opening, the second low voltage connector 72C is configured. For example, by externally fitting and connecting the low voltage external connector 17 to the second low voltage connector 72C, the second end parts of the low voltage terminals 30 are electrically connected to the connector terminals of the low voltage external connector 17. A connection direction of the low voltage external connector 17 to the second low voltage connector 72C is arbitrary and not limited to that of the above example.

Since the low voltage internal connector 12 is arranged in the case 10 of the device, position restriction is possibly imposed more on the low voltage internal connector 12 than on the low voltage external connector 17 due to space restriction in the case 10 and the layout convenience of internal components. Further, since the low voltage internal connector 12 is arranged in the case 10 through the opening 10h, position restriction is possibly imposed to prevent the low voltage internal connector 12 to largely protrude outward in terms of insertion workability and the like. From such a background, the arrangement position of the low voltage internal connector 12 is restricted and the first low voltage connector 70C to be connected to the low voltage internal connector 12 is thought to be arranged on the extension of the first end part 41 of the first busbar terminal 40A.

Position restriction is imposed less on the low voltage external connector 17 than on the low voltage internal connector 12, but the arrangement of the low voltage external connector 17 is set in consideration of a device serving as a connection destination.

Accordingly, when viewed along the center axis direction of the opening 10h, the first and second low voltage connectors 70C, 72C are thought to be set at different positions. In such a case, there is a possibility that the relay conductor portions 32 of the low voltage terminals 30 at least partially overlap the busbar terminals 40 when viewed along the thickness direction of the busbar terminals 40.

In this embodiment, the relay conductor portion 32 of the low voltage terminal 30 includes the first neck portion 32a, the intermediate coupling portion 32b and the second neck portion 32c as described above. A part of the intersecting portion 32v in the middle of the intermediate coupling portion 32b overlaps the intermediate part 42 of the first busbar terminal 40A when viewed along the thickness direction of the intermediate parts 42 of the busbar terminals 40.

The intermediate path covering portion 74 covers the first neck portions 32a, the intermediate coupling portions 32b and the second neck portions 32c. Thus, the intermediate path covering portion 74 is an elongated projecting part extending along the first neck portions 32a, the intermediate coupling portions 32b and the second neck portions 32c with respect to the first and second connector portions 54, 60.

In this embodiment, the intermediate path covering portion 74 includes a first neck covering portion 74a, an intermediate covering portion 74b and a second neck covering portion 74c. The first neck covering portion 74a is an elongated projecting part extending from the first low voltage connector housing portion 70 toward the plate-like portion 52 in a part of the outer periphery of the first connector portion 54. The second neck covering portion 74c is an elongated projecting part extending from the second low voltage connector housing portion 72 toward the plate-like portion 52 in a part of the outer periphery of the second connector portion 60. The intermediate covering portion 74b is an elongated projecting part extending while being bent along a part around a base end part of the first connector portion 54 to couple a base end part of the first neck covering portion 74a and a base end part of the second neck covering portion 74c.

As described above, depending on a positional relationship of the first and second low voltage connectors 70C, 72C, the low voltage terminals 30 overlap the busbar terminals 40 while being spaced apart, and a resin part is interposed between the busbar terminals 40 and low voltage terminals 30. The resin around the busbar terminals 40 is thought to be set to such a thickness that the formation of voids due to thermal contraction can be suppressed by properly designing the outer shape of the resin part or forming recesses for lightening in the resin part. However, it is thought to be difficult to thin the resin part between the relay conductor portions 32 and the busbar terminals 40 only by properly designing the outer shape of the resin part. Further, depending on a surrounding structure, lightening is thought to be difficult. In this embodiment, the formation of voids due to thermal contraction is suppressed in the resin part between the busbar terminals 40 and the low voltage terminals 30 in such a case.

### <Resin Part of Connector Housing and Positional Relationship of Busbar Terminals and Low Voltage Terminals>

To suppress the formation of voids due to thermal contraction in the resin part between the busbar terminals 40 and the low voltage terminals 30, description is made, focusing on the configuration of the resin part in the connector housing, the positional relationship of the busbar terminals 40 and the low voltage terminals 30 and the like. FIG. 4 is a section along IV-IV in FIG. 2 of the connector 20 in an assembled state. FIG. 5 is a section along V-V in FIG. 3 of the connector 20 in the assembled state.

The connector housing 50 includes the first resin portion 80 and the second resin portion 84. The first and second resin portions 80, 84 are made of resin such as polyamide such as nylon 6 or nylon 6T, polyphenylene sulfide (PPS), polybutylene terephthalate (PBT) or polypropylene (PP) or fiber-reinforced resin or the like. The first and second resin portions 80, 84 may be made of the same resin or may be made of different resins.

The first resin portion 80 covers the relay conductor portions 32 of the low voltage terminals 30. The first resin portion 80 is a part molded separately from the second resin portion 84. For example, the first resin portion 80 may be a part molded with the low voltage terminals 30 as insert components. After the first resin portion 80 is molded, the low voltage terminals 30 may be set in a recess formed in the first resin portion 80.

The first resin portion 80 is an elongated part continuously extending along an extension direction of the relay conductor portions 32. The first resin portion 80 includes a first neck covering portion 80a, an intermediate covering portion 80b and a second neck covering portion 80c. The first neck covering portion 80a is an elongated part for covering the first neck portions 32a. The intermediate covering portion 80b is an elongated part for covering the intermediate coupling portions 32b while being bent. The first neck covering portion 80a is an elongated part for covering the first neck portions 32a. The first resin portion 80 may continuously cover the relay conductor portions 32. The relay conductor portions 32 may be partially exposed from the first resin portion 80.

The second resin portion 84 covers the relay conductor portions 32, the first resin portion 80 and intermediate parts in the extension direction of the busbar terminals 40. In this embodiment, the second resin portion 84 covers the relay conductor portions 32 via the first resin portion 80. More specifically, the first neck covering portion 74a, the intermediate covering portion 74b and the second neck covering portion 74c of the connector housing 50 respectively cover the first neck portions 32a, the intermediate coupling portions 32b and the second neck portions 32c via the first neck covering portion 80a, the intermediate covering portion 80b and the second neck covering portion 80c. Note that the first resin portion 80 may be partially exposed from the second resin portion 84.

Further, as described above, the intermediate parts 42, parts of the first end parts 41 and parts of the second end parts 43, out of the busbar terminals 40, are covered by the second resin portion 84.

The first resin portion 80 includes a projecting portion 82 projecting toward the busbar terminals 40. The projecting portion 82 is a part projecting toward the first busbar terminal 40A in at least a part of a region overlapping the first busbar terminal 40A when viewed along the thickness direction of the first busbar terminal 40A.

More specifically, the intermediate coupling portion 80b of the first resin portion 80 is overlapped with the intermediate part 42 of the first busbar terminal 40A when viewed along the thickness direction of the first busbar terminal 40A. That is, the intermediate coupling portion 80b covers the intersecting portions 32v of the intermediate coupling portions 32b of the low voltage terminals 30, and is overlapped with the intermediate part 42 of the first busbar terminal 40A in this part. The projecting portion 82 is formed in this overlapping part of the intermediate coupling portion 80b. In this embodiment, the projecting portion 82 is formed in a part of the intermediate coupling portion 80b facing the intermediate part 42 of the first busbar terminal 40A and near the first neck covering portion 80a. In this embodiment, the projecting portion 82 includes a rectangular parallelepiped part 82a and a rectangular parallelepiped additional portion 82b projecting from a part of one side part of the rectangular parallelepiped part 82a. In FIG. 4, a region where the projecting portion 82 including the additional portion 82b is formed is shown by a cross-hatched region. The rectangular parallelepiped part 82a is located in a region on an extension of the base end side of the first end part 41 when viewed along the thickness direction of the intermediate part 42 of the first busbar terminal 40A. The additional portion 82b is located in a region projecting toward one side (here, shifted side toward the second end part 43 according to the bent shape of the intermediate part 42) from the region on the extension of the base end side of the first end part 41. That is, the additional portion 82b is a part shaped to project according to the shape of the bent part of the intermediate part 42 in the width direction of the intermediate part 42 of the first busbar terminal 40A.

The projecting portion 82 needs not be formed in the entire overlapping region of the first busbar terminal 40A and the first resin portion 80 in the thickness direction of the first busbar terminal 40A. Further, a presence region of the projecting portion 82 may protrude from the region of the first busbar terminal 40A in the thickness direction of the first busbar terminal 40A.

The projecting portion 82 is not formed in the other part, out of the intermediate coupling portion 80b. In other words, the projecting portion 82 is formed on a part of the surface facing the intermediate part 42 of the first busbar terminal 40A in the intermediate coupling portion 80b, and the other part is formed as a part recessed from the projecting portion 82. Thus, a part of the surface facing the intermediate part 42 of the first busbar terminal 40A in the intermediate coupling portion 80b is formed to be thick by the projecting portion 82, and the other part is formed to be thinner than the thickened part. Without limitation to these examples, the shape of the projecting portion 82 is arbitrary.

Either one of the thickness of the projecting portion 82 of the first resin portion 80 and the thickness of the second resin portion 84 may be large between the intermediate part 42 of the first busbar terminal 40A and the intermediate coupling portions 32b of the low voltage terminals 30. In this embodiment, the thickness of the first resin portion 80 is larger than that of the second resin portion 84 (see FIG. 5). The thickness of the second resin portion between the intermediate part 42 of the first busbar terminal 40A and the projecting portion 82 is arbitrary, but may be, for example, set to 3 mm or less.

A part of the first resin portion 80 excluding a part formed with the projecting portion 82 may cover the relay conductor portions 32 while having a smaller thickness than the part formed with the projecting portion 82.

### <Effects, Etc.>

According to the connector 20 configured as described above, the first resin portion 80 includes the projecting portion 82 projecting toward the intermediate part 42 in at least a part of the region overlapping the intermediate part 42 when viewed along the thickness direction of the intermediate part 42 of the first busbar terminal 40A. Thus, in the part formed with the projecting portion 82, a distance between the first resin portion 80 and the intermediate part 42 of the first busbar terminal 40A is reduced and the second resin portion 84 can be thinned as compared to the case where the projecting portion 82 is not formed. In this way, the amount of thermal contraction of the second resin portion 84 can be reduced and the formation of voids in the second resin portion 84 can be suppressed in the part between the busbar terminal 40 and the low voltage terminals 30. Further, since the projecting portion 82 is a partial projecting part in the first resin portion 80, a volume of the first resin portion 80 is not largely increased as compared to the case where a part of the first resin portion 80 facing the busbar terminal 40 or the entire first resin portion 80 is formed to be thick. Thus, the amount of thermal contraction of the first resin portion 80 can be reduced, whereby the formation of voids due to the thermal contraction of the first resin portion 80 is suppressed. Further, an insulation distance corresponding to the projecting portion 82 is ensured between the busbar terminal 40 and the low voltage terminals 30 by as much as the projecting portion 82 formed in the first resin portion 80.

Further, if the second resin portion 84 is made thinner than the first resin portion 80 between the busbar terminals 40 and the low voltage terminals 30, the formation of voids is effectively suppressed in the second resin portion 84 closer to the busbar terminals 40 for high voltage than the low voltage terminals 30.

Further, if intermediate coupling portions of low voltage terminals can be arranged near busbar terminals in a connector housing, the formation of voids due to thermal contraction is possibly avoided. In this case, it is thought to mold the connector housing with the low voltage terminals positioned near the busbar terminals by positioning pins to ensure the insulation distance between the busbar terminals and the low voltage terminals. However, if the first connector portion 54 is present near the busbar terminals 40 and the first nut accommodation recess 55a is present as in this embodiment, it is thought to be difficult to arrange the positioning pins near the busbar terminals 40 during molding. In this embodiment, the insulation distance can be ensured by interposing the resin thicker than the thickness of the nut N between the busbar terminals 40 and the low voltage terminals 30 if it is difficult to correctly position the low voltage terminals 30 near the busbar terminals 40 due to the shape restriction of the connector 20. In such a configuration, the formation of voids due to thermal contraction is suppressed in the second resin portion 84 by the projecting portion 82.

Further, if the tip sides of the first end parts 41 are open like the first end parts 41 of the second busbar terminals 40B, it can be easily realized to provide the second nut accommodation recesses 55b open toward the tip sides and provide the escape holes 57b on the back of the second nut accommodation recesses 55b.

In contrast, if the first low voltage connector 70C is located on the extension of the first end part 41 of the first busbar terminal 40A, it is difficult to form a lightened structure between the intermediate part 42 of the first busbar terminal 40A and the low voltage terminals 30. In this part, the formation of voids in the second resin portion 84 can be suppressed by thinning the second resin portion 84 by the projecting portion 82 of the first resin portion 80 as described above.

In this case, the first nut accommodation recess 55a corresponding to the first end part 41 of the first busbar terminal 40A may be open in the direction intersecting the extension direction of the first end part 41. In this way, the first nut accommodation recess 55a can be formed without being interrupted by the first low voltage connector 70C.

If the escape hole 57a is similarly open in the direction intersecting the extension direction of the first end part 41 of the first busbar terminal 40A, the escape hole 57a can be easily formed. Since it is difficult to form such an escape hole 57a long in a longitudinal direction of the first busbar terminal 40A, the escape hole 57a and the projecting portion 82 together can make the second resin portion 84 thin around the intermediate part of the first busbar terminal 40A.

Further, if the busbar terminal 40 includes the intermediate part 42, which is a bent part, the second resin portion 84 can be thinned between the intermediate part 42 of the first busbar terminal 42A and the low voltage terminals 30 in as large a region as possible according to the shape of the intermediate part 42, which is the bent part, if the projecting portion 82 is formed into a shape including the additional portion 82b projecting according to the shape of the bent part.

### [Modifications]

Note the low voltage terminals 30 may overlap the second busbar terminal 40B when viewed along the thickness direction of the second busbar terminal 40B. In this case, at least a part of the first resin portion 80 overlapping the second busbar terminal 40B may or may not project toward the intermediate part 42 of the second busbar terminal 40B.

Note that the above embodiment and each configuration described in each modification can be appropriately combined without contradicting each other.

### LIST OF REFERENCE NUMERALS

10 case
10h opening
11 high voltage internal busbar
12 low voltage internal connector
16 high voltage external terminal
17 low voltage external connector
20 connector
22 metal plate
24 annular seal
25 mounting piece
25a pin portion
30 low voltage terminal
31 first connector terminal portion
32 relay conductor portion
32 first neck portion
32b intermediate coupling portion
32 second neck portion
32v intersecting portion
33 second connector terminal portion
40 busbar terminal (40A first busbar terminal, 40B second busbar terminal)
41 first end part
41h, 43h bolt insertion hole
42 intermediate part
43 second end part
50 connector housing
52 plate-like portion
52P positioning protrusion
54 first connector portion
55a, 55b second nut accommodation recess
56a, 56b escape recess
57a, 57b escape hole
60 second connector portion
62 outer wall portion
62a main wall portion
62h, 62h2 opening
64 base portion
65 busbar end accommodation recess
66 nut accommodation recess
70 first low voltage connector housing portion
70C first low voltage connector
72 second low voltage connector housing portion
72C second low voltage connector
74 intermediate path covering portion
74a, 80a first neck covering portion
74b, 80b intermediate covering portion
74c, 80c second neck covering portion
80 first resin portion
82 projecting portion
82a rectangular parallelepiped part
82b additional portion
84 second resin portion
B bolt
N nut

1. A connector, comprising:
a low voltage terminal including a first connector terminal portion, a second connector terminal portion and a relay conductor portion between the first and second connector terminal portions;
a busbar terminal in the form of a long plate; and
a connector housing including a first resin portion for covering the relay conductor portion and a second resin portion for covering the relay conductor portion, the first resin portion and an intermediate part in an extension direction of the busbar terminal,
the first resin portion including a projecting portion projecting toward the busbar terminal in at least a part of a region overlapping the busbar terminal when viewed along a thickness direction of the busbar terminal.

2. The connector of claim 1, wherein:
the second resin portion includes a nut accommodation recess for accommodating a nut in contact with one principal surface of one end part of the busbar terminal, and
the low voltage terminal is located away from the busbar terminal by a thickness of the nut or more in the thickness direction of the busbar terminal in the connector housing.

3. The connector of claim 1, wherein:
the connector housing includes a low voltage connector housing portion surrounding the first connector terminal portion,
the busbar terminals include a first busbar terminal,
the low voltage connector housing portion is located on an extension of one end part of the first busbar terminal, and
the projecting portion includes a part projecting toward the first busbar terminal in at least a part of a region overlapping the first busbar terminal when viewed along a thickness direction of the first busbar terminal.

4. The connector of claim 3, wherein:
the second resin portion includes a first nut accommodation recess for accommodating a first nut in contact with one principal surface of the one end part of the first busbar terminal, and
the first nut accommodation recess is open in a direction intersecting an extension direction of the one end part of the first busbar terminal.

5. The connector of claim 4, wherein:
the busbar terminals include a second busbar terminal arranged at an interval from and in parallel to the first busbar terminal,
the second resin portion includes a second nut accommodation recess for accommodating a second nut in contact with one principal surface of one end part of the second busbar terminal, and
the second nut accommodation recess is open toward a tip side of the first busbar terminal.

6. The connector of claim 1, wherein:
the busbar terminal includes a bent part bent to be displaced in a width direction thereof, and
the projecting portion is formed into a shape projecting according to the shape of the bent part in the width direction of the busbar terminal.
